(19) United States
(12) Patent Application Publication
(10) Pub. No.: US 2025/0137601 A1
(43) Pub. Date: May 1, 2025

(54) CEILING LAMP WITH NIGHT LAMP

(71) Applicant: Xiamen Topstar Lighting Co., Ltd., Xiamen (CN)

(72) Inventors: Xibin LIN, Xiamen (CN); Haipeng HONG, Xiamen (CN); Dening LI, Xiamen (CN); Chuanbao YE, Xiamen (CN)

(73) Assignee: Xiamen Topstar Lighting Co., Ltd., Xiamen (CN)

(21) Appl. No.: 19/007,979

(22) Filed: Jan. 2, 2025

(30) Foreign Application Priority Data
Dec. 5, 2024 (CN) 202422995910.X

(51) Int. Cl. F21S 8/04; F21V 7/28; F21V 15/01; F21V 17/10; F21V 17/12

(52) U.S. Cl. CPC F21S 8/046; F21V 7/28; F21V 15/01; F21V 17/101; F21V 17/12

(57) ABSTRACT

A ceiling lamp with a night lamp includes a chassis, a diffusion cover, a main light source, a light shield, and a night lamp light source. The diffusion cover is disposed on the chassis, and the chassis and the diffusion cover are enclosed to form an accommodating cavity; and the main light source is disposed in the accommodating cavity, the light shield is disposed in the accommodating cavity and is disposed around the main light source, and the night lamp light source is disposed on an outer wall surface of the diffusion cover. The main light source of the ceiling lamp with the night lamp is used for emitting strong light, and the night lamp light source is used for emitting weak light. The light shield is used for limiting an irradiation direction of the night lamp light source.

### CROSS-REFERENCE TO RELATED APPLICATIONS

This application claims priority to Chinese Patent Application No. 202422995910.X, filed on Dec. 5, 2024, the content of which is incorporated herein by reference in its entirety.

### TECHNICAL FIELD

The present application relates to the technical field of lamps, in particular to a ceiling lamp with a night lamp.

### BACKGROUND

For the current ceiling lamp, in order to switch the brightness, the number of light emitting beads is usually reduced, which easily leads to uneven rays to affect visual perception. Moreover, in order to meet the need of daily lighting, the light emitting intensity of the bead of the ceiling lamp is usually relatively high. Even if the light intensity is switched to a lower state, the ceiling lamp is still dazzling and cannot meet some application scenarios that require weaker light, such as an application scenario that the ceiling lamp is used as a night light at night.

### SUMMARY

A technical problem to be solved in the present application is to provide a ceiling lamp with a night lamp.

In order to solve the above-mentioned technical problem, the present application adopts a technical solution that: a ceiling lamp with a night lamp includes a chassis, a diffusion cover, a main light source, a light shield, and a night lamp light source, wherein the diffusion cover is disposed on the chassis, and the chassis and the diffusion cover are enclosed to form an accommodating cavity; and the main light source is disposed in the accommodating cavity, the light shield is disposed in the accommodating cavity and is disposed around the main light source, and the night lamp light source is disposed on an outer wall surface of the diffusion cover.

Further, the light shield is engaged with the chassis or is connected to the chassis via a screw.

Further, the ceiling lamp with the night lamp further includes a night lamp lens disposed to cover the night lamp light source.

Further, the light shield is provided with a limiting groove, and the night lamp lens is clamped and matched with the limiting groove.

Further, the ceiling lamp with the night lamp further includes a transparent main lamp cover disposed to cover the main light source.

Further, contact surfaces of the diffusion cover and the chassis are respectively provided with clamping grooves and clamping blocks engaged and matched with the clamping grooves.

Further, the chassis is made of aluminum.

Further, the outer wall surface of the diffusion cover is provided with at least one decorative ring.

Further, the at least one decorative ring is connected to the diffusion cover by gluing.

Further, an outer wall surface of the light shield is provided with a light reflective coating.

The present application has the beneficial effects that the main light source of the ceiling lamp with the night lamp is used for emitting strong light so as to meet application scenarios with higher requirements on light intensity, and the night lamp light source is used for emitting weak light so as to meet demands of environments where the weak light is used at night. The light shield is used for limiting an irradiation direction of the night lamp light source and ensuring that rays emitted from the night lamp light source are diffused to an outer side of the ceiling lamp, thereby reducing rays propagated downwards.

### BRIEF DESCRIPTION OF THE DRAWINGS

FIG. 1 is a sectional view of a ceiling lamp with a night lamp in embodiment 1 of the present application.

FIG. 2 is an enlarged detail view of part A in FIG. 1.

FIG. 3 is an exploded view of the ceiling lamp with the night lamp in embodiment 1 of the present application.

### DETAILED DESCRIPTION OF THE EMBODIMENTS

In order to describe the technical contents, achieved objects and effects of the present application in detail, following description is shown in conjunction with implementations and cooperation with the accompanying drawings.

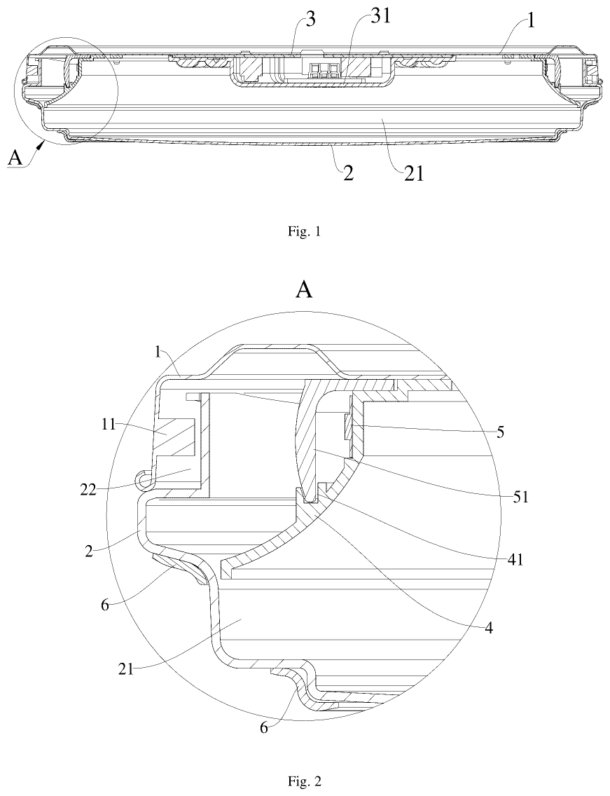

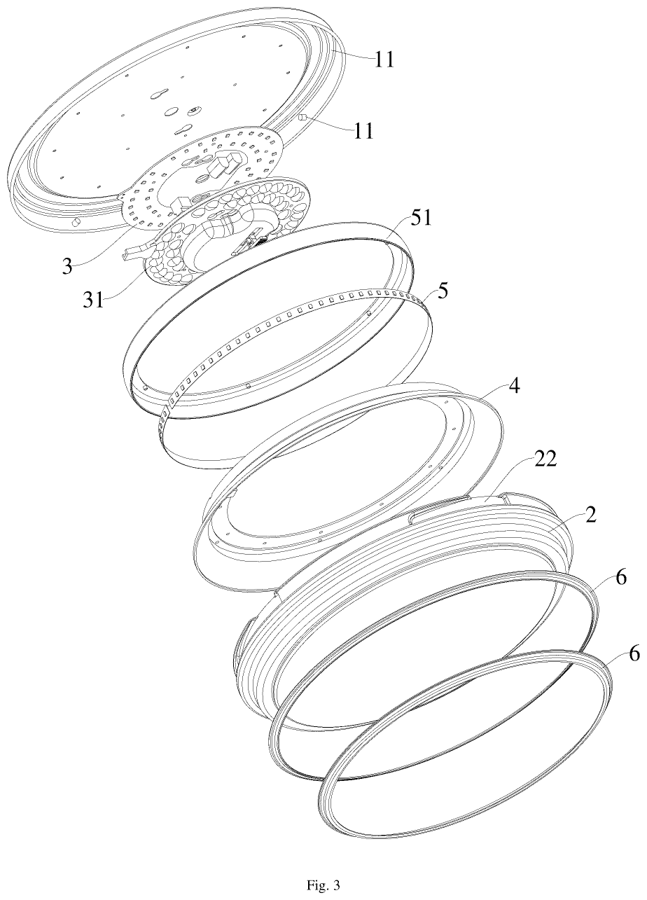

Referring to FIG. 1 to FIG. 3, a ceiling lamp with a night lamp includes a chassis 1, a diffusion cover 2, a main light source 3, a light shield 4, and a night lamp light source 5, wherein the diffusion cover 2 is disposed on the chassis 1, and the chassis 1 and the diffusion cover 2 are enclosed to form an accommodating cavity 21; and the main light source 3 is disposed in the accommodating cavity 21, the light shield 4 is disposed in the accommodating cavity 21 and is disposed around the main light source 3, and the night lamp light source 5 is disposed on an outer wall surface of the diffusion cover 2.

It can be known from the above-mentioned description that the present application has the beneficial effects that the main light source 3 of the ceiling lamp with the night lamp is used for emitting strong light so as to meet application scenarios with higher requirements on light intensity, and the night lamp light source 5 is used for emitting weak light so as to meet demands of environments where the weak light is used at night. The light shield 4 is used for limiting an irradiation direction of the night lamp light source 5 and ensuring that rays emitted from the night lamp light source 5 are diffused to an outer side of the ceiling lamp, thereby reducing rays propagated downwards.

Further, the light shield 4 is engaged with the chassis 1 or is connected to the chassis 1 via a screw.

It can be known from the above-mentioned description that the light shield 4 and the chassis 1 are simple in connection way and convenient to assemble.

Further, the ceiling lamp with the night lamp further includes a night lamp lens 51 disposed to cover the night lamp light source 5.

It can be known from the above-mentioned description that the night lamp lens 51 can protect the night lamp light source 5 and can also play roles in refracting and diffusing rays.

Further, the light shield 4 is provided with a limiting groove 41, and the night lamp lens 51 is clamped and matched with the limiting groove 41.

It can be known from the above-mentioned description that the night lamp lens 51 is simple in assembly way and convenient to disassemble and assemble.

Further, the ceiling lamp with the night lamp further includes a transparent main lamp cover 31 disposed to cover the main light source 3.

It can be known from the above-mentioned description that the night lamp lens 51 can protect the main light source 3 and can also play roles in refracting and diffusing rays.

Further, contact surfaces of the diffusion cover 2 and the chassis 1 are respectively provided with clamping grooves 22 and clamping blocks 11 engaged and matched with the clamping grooves 22.

It can be known from the above-mentioned description that the diffusion cover 2 and the chassis 1 are simple in connection way and convenient to disassemble and assemble.

Further, the chassis 1 is made of aluminum.

It can be known from the above-mentioned description that aluminum is strong in plasticity, convenient to manufacture, lower in density, and beneficial to the reduction of the overall weight of the ceiling lamp with the night lamp.

Further, the outer wall surface of the diffusion cover 2 is provided with at least one decorative ring 6.

It can be known from the above-mentioned description that the at least one decorative ring 6 can play a role in shielding excess rays and can decorate the appearance of the ceiling lamp with the night lamp.

Further, the at least one decorative ring 6 is connected to the diffusion cover 2 by gluing.

It can be known from the above-mentioned description that the at least one decorative ring 6 and the diffusion cover 2 are simple in connection way and convenient to assemble.

Further, an outer wall surface of the light shield 4 is provided with a light reflective coating.

It can be known from the above-mentioned description that the light reflective coating can improve the light reflection capacity of the light shield 4 and is beneficial to the reduction of the power of the night lamp light source 5.

Referring to FIG. 1 to FIG. 3, embodiment 1 of the present application is that: a ceiling lamp with a night lamp includes a chassis 1, a diffusion cover 2, a main light source 3, a light shield 4, and a night lamp light source 5, wherein the diffusion cover 2 is disposed on the chassis 1, and the chassis 1 and the diffusion cover 2 are enclosed to form an accommodating cavity 21; and the main light source 3 is disposed in the accommodating cavity 21, the light shield 4 is disposed in the accommodating cavity 21 and is disposed around the main light source 3, and the night lamp light source 5 is disposed on an outer wall surface of the diffusion cover 2.

In the present embodiment, the chassis 1 is made of aluminum. The diffusion cover 2 is connected to the downside of the chassis 1, and the main light source 3 is fixedly mounted on the chassis 1. The main light source 3 includes a lamp panel and a plurality of main beads disposed on the lamp panel. The light shield 4 is horn-shaped, and the maximum width of the light shield 4 is gradually increased from the top to the bottom. The night lamp light source 5 includes a lamp strip and a plurality of night lamp beams connected to the lamp strip, and the lamp strip is disposed around the light shield 4.

In the present embodiment, a through hole allowing a screw to penetrate is formed in the top of the light shield 4 so that the light shield 4 is connected to the chassis 1 via the screw. In other embodiments, the light shield 4 can also be engaged with the chassis 1.

The ceiling lamp with the night lamp further includes a night lamp lens 51 disposed to cover the night lamp light source 5. Optionally, the night lamp lens 51 is made of plastics or glass.

The light shield 4 is provided with a limiting groove 41, and the night lamp lens 51 is clamped and matched with the limiting groove 41. Specifically, the limiting groove 41 is disposed in an outer wall surface of the light shield 4, the bottom of the night lamp lens 51 is clamped and matched with the limiting groove 41, and the top of the night lamp lens 51 is disposed between the light shield 4 and the chassis 1.

As a preferred implementation, the outer wall surface of the light shield 4 is provided with a light reflective coating which can improve the light reflection capacity of the light shield 4 and is beneficial to the reduction of the power of the night lamp light source 5.

The ceiling lamp with the night lamp further includes a transparent main lamp cover 31 disposed to cover the main light source 3. Specifically, the transparent main lamp cover 31 is connected to the chassis 1 via a screw. Optionally, the transparent main lamp cover 31 is made of plastics or glass.

Contact surfaces of the diffusion cover 2 and the chassis 1 are respectively provided with clamping grooves 22 and clamping blocks 11 engaged and matched with the clamping grooves 22. In the present embodiment, the outer wall surface of the diffusion cover 2 and an inner wall surface of the chassis 1 are both composed of a side of a rotator, the clamping grooves 22 are formed in the outer wall surface of the diffusion cover 2 and are L-shaped, and one end of each of the clamping grooves 22 is connected to the top surface of the diffusion cover 2. The number of the clamping grooves 22 corresponds to the number of the clamping blocks 11 one by one, a plurality of clamping grooves 22 are provided, and the plurality of clamping grooves 22 are uniformly distributed around the outer wall surface of the diffusion cover 2. In other embodiments, the clamping grooves 22 are formed in the chassis 1, and the clamping blocks 11 can also be disposed on the diffusion cover 2.

The outer wall surface of the diffusion cover 2 is provided with at least one decorative ring 6. In the present embodiment, two decorative rings 6 are provided. Optionally, the at least one decorative ring 6 is connected to the diffusion cover 2 by gluing, the outer wall surface of the diffusion cover 2 is provided with a ring groove for accommodating the at least one decorative ring 6, or the at least one decorative ring 6 is in interference fit with the diffusion cover 2.

In conclusion, the main light source of the ceiling lamp with the night lamp provided in the present application is used for emitting strong light so as to meet application scenarios with higher requirements on light intensity, and the night lamp light source is used for emitting weak light so as to meet demands of environments where the weak light is used at night. The light shield is used for limiting an irradiation direction of the night lamp light source and ensuring that rays emitted from the night lamp light source are diffused to an outer side of the ceiling lamp, thereby reducing rays propagated downwards.

Above descriptions are only embodiments of the present application, and are not intended to hence limit the patent scope of the present application. Any equivalent transformations made according to the contents of the description and the accompanying drawings of the present application are directly or indirectly applied to the related art and also fall within the patent protection scope of the present application in a similar way.

What is claimed is:

1. A ceiling lamp with a night lamp, comprising a chassis, a diffusion cover, a main light source, a light shield, and a night lamp light source, wherein
the diffusion cover is disposed on the chassis, and the chassis and the diffusion cover are enclosed to form an accommodating cavity; and
the main light source is disposed in the accommodating cavity, the light shield is disposed in the accommodating cavity and is disposed around the main light source, and the night lamp light source is disposed on an outer wall surface of the diffusion cover.

2. The ceiling lamp with the night lamp according to claim 1, wherein the light shield is engaged with the chassis or is connected to the chassis via a screw.

3. The ceiling lamp with the night lamp according to claim 1, further comprising a night lamp lens disposed to cover the night lamp light source.

4. The ceiling lamp with the night lamp according to claim 3, wherein the light shield is provided with a limiting groove, and the night lamp lens is clamped and matched with the limiting groove.

5. The ceiling lamp with the night lamp according to claim 1, further comprising a transparent main lamp cover disposed to cover the main light source.

6. The ceiling lamp with the night lamp according to claim 1, wherein contact surfaces of the diffusion cover and the chassis are respectively provided with clamping grooves and clamping blocks engaged and matched with the clamping grooves.

7. The ceiling lamp with the night lamp according to claim 1, wherein the chassis is made of aluminum.

8. The ceiling lamp with the night lamp according to claim 1, wherein the outer wall surface of the diffusion cover is provided with at least one decorative ring.

9. The ceiling lamp with the night lamp according to claim 8, wherein the at least one decorative ring is connected to the diffusion cover by gluing.

10. The ceiling lamp with the night lamp according to claim 1, wherein an outer wall surface of the light shield is provided with a light reflective coating.
